(19) United States
(12) Patent Application Publication
(10) Pub. No.: US 2026/0177689 A1
(43) Pub. Date: Jun. 25, 2026

(54) VEHICLE ASSEMBLY COMPRISING A RADAR SENSOR AND AN ARRANGEMENT OF LAYERS

(71) Applicant: VALEO VISION, Bobigny (FR)

(72) Inventors: Pierre RENAUD, Bobigny (FR); Pierre ALBOU, Bobigny (FR)

(73) Assignee: VALEO VISION, Bobigny (FR)

(21) Appl. No.: 18/854,703

(22) PCT Filed: Mar. 29, 2023
(86) PCT No.: PCT/EP2023/058201

§ 371 Date: Oct. 7, 2024

(30) Foreign Application Priority Data
Apr. 12, 2022 (FR) 2203349

(51) Int. Cl. G01S 13/931

(52) U.S. Cl. CPC G01S 13/931

(57) ABSTRACT

A vehicle including a radar sensor and an arrangement of layers placed facing the radar sensor and configured to perform a luminous function, including a first sub-assembly of at least one layer that is reflective in the visible domain, each layer having a primary refractive index and a primary thickness, and a second sub-assembly of at least one layer that is transparent in the visible domain, each layer having a secondary refractive index, the primary refractive index being high with respect to the secondary refractive index, with the total thickness of the first sub-assembly of layers is dimensioned so that there is a phase shift of π modulo 2π between the waves of the radar waves incident on the outer face of the first sub-assembly and the waves reflected by the interface between the first sub-assembly and the second sub-assembly as they exit the first sub-assembly.

### TECHNICAL FIELD

The present invention relates to a vehicle assembly. It is particularly applicable, but not limited, to automotive vehicles.

### BACKGROUND OF THE INVENTION

A vehicle assembly known to those skilled in the art comprises:
a radar sensor configured to transmit radar waves; and
an arrangement of layers placed facing said radar sensor, including a reflective layer having a high refractive index with respect to radar waves in comparison to the other layers of the arrangement of layers.

The arrangement of layers forms an illuminated logo. The radar sensor is thus placed behind the illuminated logo and meets requirements for detecting an object in the environment outside the vehicle.

One drawback of this prior art is that when a radar wave is transmitted by the radar sensor, it travels to the arrangement of layers and is reflected by the arrangement of layers. This generates in particular three reflected waves, one of which has been reflected by the outer face of the arrangement of layers and the other two of which have been reflected inside the arrangement of layers. The three reflected waves are reflected waves referred to as first order reflected waves, which return to the radar sensor. This hinders the propagation of the radar waves. This reduces the signal-to-noise ratio of said radar sensor and thus causes disturbances in the detection by the radar sensor. The radar sensor loses detection range. Consequently, this can lead to a detection error or to the non-detection of an object even when said object is present in the environment outside the vehicle.

### SUMMARY OF THE INVENTION

In this context, the present invention aims to propose a vehicle assembly that makes it possible to overcome the aforementioned drawback.

To this end, the invention proposes a vehicle assembly for a vehicle, said vehicle assembly comprising:
a radar sensor configured to transmit radar waves in a range of wavelengths; and
an arrangement of layers placed facing said radar sensor and configured to perform a luminous function, said arrangement of layers comprising a first sub-assembly of at least one layer that is reflective in the visible domain, each layer having a primary refractive index and a primary thickness, and a second sub-assembly of at least one layer that is transparent in the visible domain, each layer having a secondary refractive index, said primary refractive index being high with respect to said secondary refractive index in the radar domain,
characterized in that:
the total thickness of said first sub-assembly of layers is dimensioned so that there is a phase shift of π modulo 2π between the waves of the radar waves incident on the outer face of said first sub-assembly and the waves reflected by the interface between said first sub-assembly and said second sub-assembly as they exit said first sub-assembly.

According to non-limiting embodiments, said vehicle assembly can further comprise, alone or in any technically possible combination, one or more additional features selected from the following.

According to one non-limiting embodiment, the total thickness of said second sub-assembly of layers is dimensioned so that there is a phase shift of π modulo 2π between the waves of the radar waves incident on the outer face of said first sub-assembly and the waves reflected by the outer face of said second sub-assembly as they exit said first sub-assembly.

According to one non-limiting embodiment, the total thickness of said second sub-assembly of layers is dimensioned by modifying the thickness of just one of the layers of said second sub-assembly.

According to one non-limiting embodiment, each layer of said first sub-assembly has a refractive index that differs from the refractive index of another adjacent layer of said first sub-assembly by less than 0.1 in the radar domain.

According to one non-limiting embodiment, each layer of said second sub-assembly has a refractive index that differs from the refractive index of another adjacent layer of said second sub-assembly by less than 0.1 in the radar domain.

According to one non-limiting embodiment, each layer of said second sub-assembly has a refractive index that differs from the refractive index of a layer of said first sub-assembly by more than 0.1 in the radar domain.

According to one non-limiting embodiment, said vehicle assembly comprises at least one light source configured to emit visible light that enters said arrangement of layers through an edge of one of the layers of said second sub-assembly of said arrangement of layers.

According to one non-limiting embodiment, said at least one layer that is reflective in the visible domain is made up of particles of titanium.

According to one non-limiting embodiment, the arrangement of layers forms an illuminated logo or an illuminated front-end grille or forms part of a headlamp.

According to one non-limiting embodiment, said radar sensor is a millimeter wave or a very-high-frequency wave or a microwave radar sensor.

According to one non-limiting embodiment, said radar waves are transmitted in a frequency band of between 100 MHz and 5 GHz.

According to one non-limiting embodiment, the luminous function is a lighting and/or signaling function.

According to one non-limiting embodiment, the second sub-assembly of layers comprises:
an exit layer that forms an exit outer lens of the arrangement of layers; and
a protective layer.

According to one non-limiting embodiment, the first sub-assembly of layers is a diffusing reflective white sub-assembly.

According to one non-limiting embodiment, the total thickness of said first sub-assembly is determined for an angle of incidence that is equal to arctan (d1/(2e4)), where e4 is the distance between said radar sensor and said arrangement of layers and d1 is the distance between a transmit antenna and receive antennas of said radar sensor.

The invention further proposes an arrangement of layers placed facing a radar sensor, said radar sensor being configured to transmit radar waves in a range of wavelengths, said arrangement of layers being configured to perform a luminous function and comprising a first sub-assembly of at least one layer that is reflective in the visible domain, each layer having a primary refractive index and a primary thickness, and a second sub-assembly of at least one layer that is transparent in the visible domain, each layer having a secondary refractive index, said primary refractive index being high with respect to said secondary refractive index,
characterized in that:
the total thickness of said first sub-assembly of layers is dimensioned so that there is a phase shift of π modulo 2π between the waves of the radar waves incident on the outer face of said first sub-assembly and the waves reflected by the interface between said first sub-assembly and said second sub-assembly as they exit said first sub-assembly.

### BRIEF DESCRIPTION OF DRAWINGS

The invention and the various applications thereof will be better understood on reading the following description and on studying the accompanying figures, in which:

FIG. 1 is a schematic view of a vehicle assembly, said vehicle assembly comprising a radar sensor and an arrangement of layers, said arrangement of layers comprising a first sub-assembly of layers and a second sub-assembly of layers, according to one non-limiting embodiment of the invention,

FIG. 2 is a front view of the vehicle assembly in FIG. 1, according to one non-limiting embodiment, said vehicle assembly further comprising a light decoupling relief structure, according to one non-limiting embodiment,

FIG. 3 is a schematic view of a radar wave transmitted by the radar sensor of the vehicle assembly in FIG. 1 or FIG. 2, which generates reflected waves that are reflected by one face of the arrangement of layers of the vehicle assembly in FIG. 1 or FIG. 2 and inside said arrangement of layers, according to one non-limiting embodiment,

FIG. 4 is a schematic view of a radar wave transmitted by the radar sensor of the vehicle assembly in FIG. 1 or FIG. 2, which generates reflected waves that are reflected by two faces of the arrangement of layers of the vehicle assembly in FIG. 1 or FIG. 2, according to one non-limiting embodiment,

FIG. 5 is a schematic view of the layers of the arrangement of layers of the vehicle assembly in FIG. 1 or FIG. 2, said arrangement of layers comprising a first sub-assembly of layers and a second sub-assembly of layers, according to one non-limiting embodiment,

FIG. 6 is a first graph of results showing two reflectivity curves relating to a radar wave from the radar sensor in FIG. 1, when the second sub-assembly of the arrangement of layers in FIG. 1 is optimized so as to minimize the reflected waves in FIG. 3, according to one non-limiting embodiment,

FIG. 7 is a first graph of results showing two reflectivity curves relating to a radar wave from the radar sensor in FIG. 1, when the second sub-assembly of the arrangement of layers in FIG. 1 is optimized so as to minimize the reflected waves in FIG. 3, and when the first sub-assembly of layers of the arrangement of layers in FIG. 1 is optimized so as to minimize the reflected waves in FIG. 4, according to one non-limiting embodiment.

### DETAILED DESCRIPTION OF THE INVENTION

Elements that are identical, in structure or in function, and that appear in several figures use the same reference signs, unless otherwise specified.

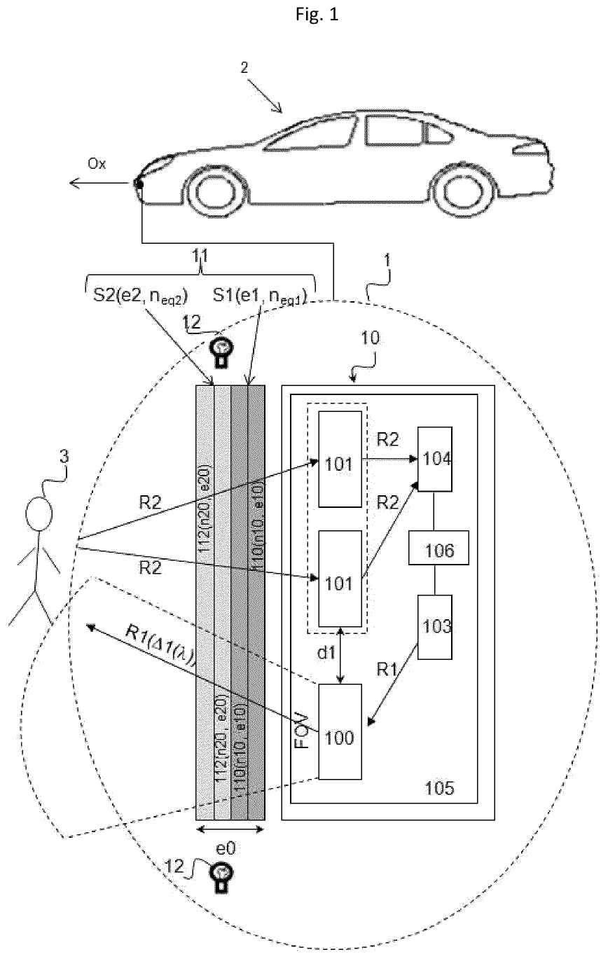

The vehicle assembly 1 for a vehicle 2 according to the invention is described with reference to FIGS. 1 to 7. The vehicle assembly 1 is also referred to as the vehicle system 1. In one non-limiting embodiment, the vehicle 2 is an automotive vehicle. The term automotive vehicle is given to mean any type of motorized vehicle. This embodiment is given as a non-limiting example in the remainder of the description. In the remainder of the description, the vehicle 2 is thus also referred to as the automotive vehicle 2. In one non-limiting embodiment, the vehicle assembly 1 is placed in the grille of the automotive vehicle 2. In another non-limiting embodiment, the vehicle assembly 1 can be incorporated into a body part located at the rear of the automotive vehicle 2.

As illustrated in FIG. 1, the vehicle assembly 1, also referred to as the vehicle arrangement 1, comprises:
a radar sensor 10 configured to transmit radar waves R1; and
an arrangement of layers 11 placed facing said radar sensor 10.

These elements are described below.

The radar sensor 10 is described below. As illustrated in FIG. 1, the radar sensor 10 is placed facing the arrangement of layers 11. In one non-limiting embodiment, the radar sensor 10 is a millimeter-wave (between 24 GHz and 300 GHz) or very-high-frequency (between 300 MHz and 81 GHz) or microwave (between 1 GHz and 300 GHz) radar sensor. In one non-limiting variant, the radar sensor 10 operates at a radar frequency of between 76 GHz and 81 GHz. The radar waves R1 are transmitted in a range Δ1 of wavelengths λ. In one non-limiting embodiment, the radar waves R1 are transmitted in a frequency band of between 100 MHz and 5 GHZ. In one non-limiting example, if the radar sensor 10 operates at a radar frequency of 77 GHz, i.e. a wavelength λ of 3.95 mm, with a frequency band of 1 GHz, the radar sensor 10 will thus operate in a frequency band from 76.5 GHz to 77.5 GHz. The radar waves R1 will thus be transmitted in the frequency range 76.5 GHz to 77.5 GHZ, i.e. a range Δ1 of wavelengths λ from 3.87 mm to 3.92 mm. In another non-limiting example, if the radar sensor 10 operates at a radar frequency of 78.5 GHz with a frequency band of 5 GHz, the radar sensor 10 will thus operate in a frequency band from 76 GHz to 81 GHz. The radar waves R1 will thus be transmitted in the frequency range 76 GHz to 81 GHz, i.e. a range Δ1 of wavelengths λ from 3.701 mm to 3.945 mm.

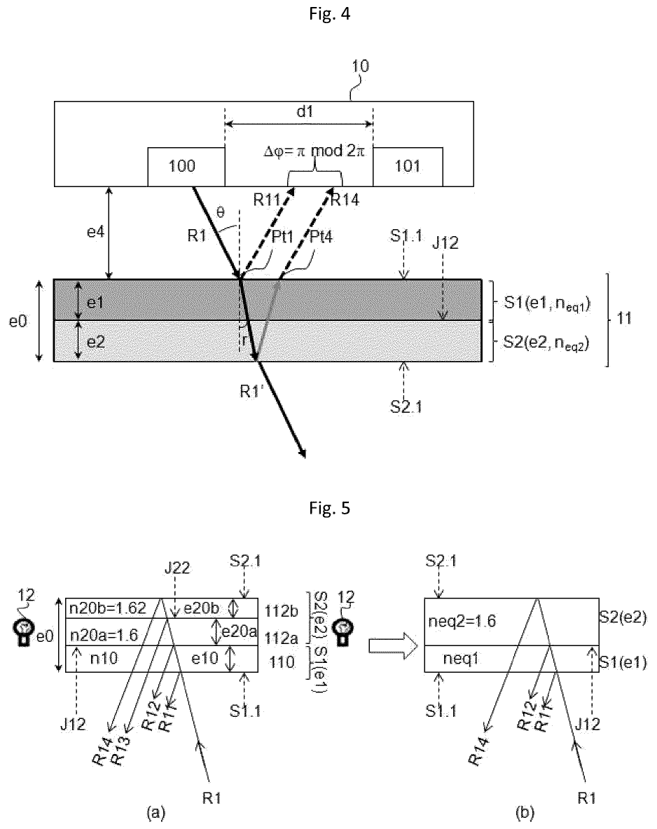

As illustrated in FIGS. 3 and 4, the transmitted radar waves R1 strike the arrangement of layers 11 at an angle of incidence θ. In one non-limiting embodiment, the angle of incidence θ is between 0° and +/−30°. The radar sensor 10 thus comprises a field of view FOV that thus varies between −30° and +30°. The center of the field of view FOV is at an angle of 0° relative to the longitudinal axis of the vehicle Ox, also referred to as the vehicle axis Ox. In another non-limiting embodiment, the field of view FOV varies between −90° and +45°. The center of the field of view FOV is at an angle of −45° relative to the vehicle axis Ox and the angle of incidence θ of the radar waves R1 on the arrangement of layers 11 remains close to 0° (the vehicle assembly 1 then being positioned at approximately 45° to the vehicle axis Ox).

The radar sensor 10 is configured to scan the environment outside the automotive vehicle 2, by transmitting radar waves R1. As illustrated in FIG. 1, the radar sensor 10 thus comprises:
at least one transmit antenna 100 configured to transmit radar waves R1, also referred to as primary radar waves R1,
at least two receive antennas 101 configured to receive radar waves R2, also referred to as secondary radar waves R2 or return radar waves R2.

The radar sensor 10 further comprises at least one transmitter 103 configured to generate the primary radar waves R1 and at least one receiver 104 configured to process the secondary radar waves R2 received in return. In one non-limiting embodiment, a single electronic component can be used for both the transmit and receive functions. There will thus be one or more transceivers. Said transmitter 103 generates primary radar waves R1, which are subsequently transmitted by the transmit antenna 100, and which, when they encounter an object 3 (here a pedestrian in the non-limiting example illustrated) in the environment outside the automotive vehicle 2, are reflected by said object 3. The radar waves thus reflected are waves that are transmitted back to the radar sensor 10. These are the secondary radar waves R2 received by the receive antennas 101. These are radar waves transmitted back toward the radar sensor 10. In one non-limiting embodiment, the primary radar waves R1 and the secondary radar waves R2 are radio-frequency waves. In one non-limiting embodiment, the radar sensor 10 comprises a plurality of transmitters 103 and a plurality of receivers 104.

The transmit antenna 100, also referred to as the antenna 100, is configured to transmit the primary radar waves R1 generated by the transmitter 103. The receive antennas 101, also referred to as antennas 101, are configured to receive the secondary radar waves R2 and communicate them to the receiver 104, which subsequently processes them. There is a phase shift between the secondary radar waves R2 received by the receive antennas 101, which makes it possible to deduce the angular position of the object 3 relative to the automotive vehicle 2, said object 3 being located in the environment outside the automotive vehicle 2. In non-limiting embodiments, the antennas 100, 101 are patch antennas or slot antennas.

In one non-limiting embodiment, the antennas 100, 101, the transmitter 103 and the receiver 104 are placed on a printed circuit board 105. In one non-limiting embodiment, the printed circuit board is a printed circuit board assembly (PCBA) or a flexible printed circuit board (flexboard).

The radar sensor 10 further comprises an electronic control unit 106 configured to control the transmitter 103 and the receiver 104. Since such a radar sensor is known to those skilled in the art, it will not be described in more detail here.

The arrangement of layers 11 is described below. As illustrated in FIG. 1 or FIGS. 3 to 5, it comprises:
a first sub-assembly S1 of at least one layer 110 that is reflective in the visible domain, and
a second sub-assembly S2 of at least one layer 112.

The arrangement of layers 11 is configured to perform a luminous function. The first sub-assembly S1 and the second sub-assembly S2 work together to perform said luminous function. In one non-limiting embodiment, the luminous function is a lighting and/or signaling function. It is a so-called regulatory luminous function.

It will be noted that since FIG. 1 is a schematic view, just two layers 110 have been illustrated in FIG. 1 and just two layers 112 have been illustrated in FIG. 1. In the remainder of the description, the first sub-assembly S1 of layers 110 is also referred to as the first sub-assembly S1, and the second sub-assembly S2 of layers 112 is also referred to as the second sub-assembly S2.

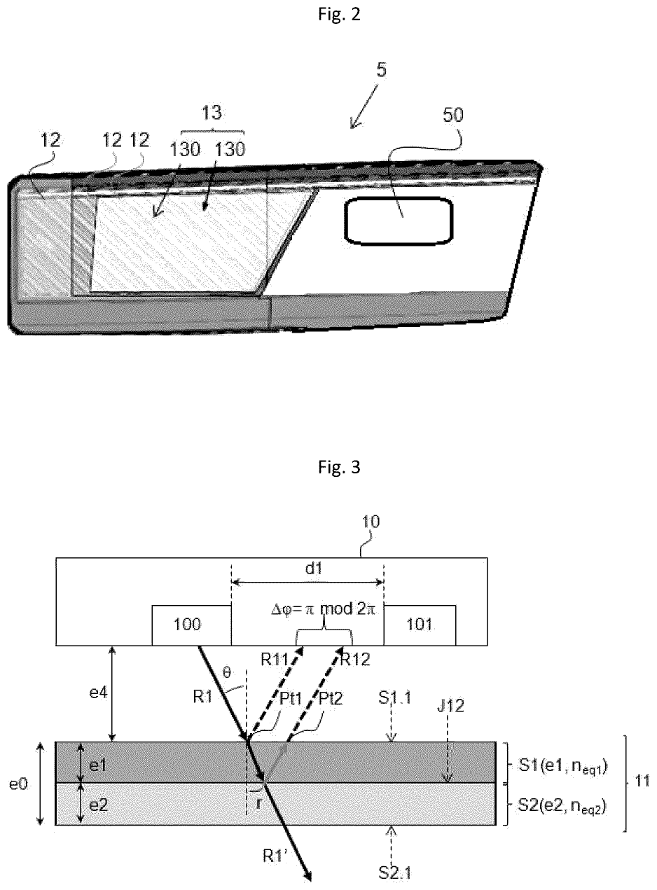

In non-limiting embodiments, the arrangement of layers 11 forms an illuminated logo or an illuminated front-end grille or forms part of a headlamp. In these cases, the vehicle assembly 1 comprises one or more light sources 12. The logo or the front-end grille or the decoupling relief structure 13 (described hereinafter) are thus lit by a plurality of light sources 12. In one non-limiting embodiment, said vehicle assembly 1 thus comprises at least one light source 12 configured to emit visible light Lx, also referred to as light Lx or light, which enters said arrangement of layers 11 through an edge. In the non-limiting example illustrated in FIG. 2, the light sources 12 are placed on the periphery of said arrangement of layers 11, level with the layers 112 of the second sub-assembly S2. In this non-limiting example, the arrangement of layers 11 forms part of a headlamp 5 that also comprises a luminous module 50 that also has one or more light sources (not illustrated).

The light sources 12 generate light rays (not illustrated) and produce the light Lx that is injected into the transparent layers 112 and reflected by said at least one layer 110. It will be noted in particular that one of the transparent layers 112 is configured to act as a light guide for said light Lx, and the other layers 112 are styling or protective layers (for corrosion protection in one non-limiting example).

In one non-limiting embodiment, the light sources 12 are semiconductor light sources. In one non-limiting embodiment, the semiconductor light sources form part of a light-emitting diode. Light-emitting diode is given to mean any type of light-emitting diode, whether these are, in non-limiting examples, LEDs, OLEDs (organic LEDs), AMOLEDs (active-matrix-organic LED), or even FOLEDs (flexible OLEDs). In another non-limiting embodiment, the light sources 12 are a bulb with a filament.

As illustrated in FIG. 1, the first sub-assembly S1 of layers 110 is placed facing the radar sensor 10, while the second sub-assembly S2 of layers 112 is adjacent to the first sub-assembly S1 of layers 110 and is placed facing the outside of the automotive vehicle 2.

In a first non-limiting embodiment, the first sub-assembly S1 is a diffusing reflective sub-assembly, that is, said at least one layer 110 is diffusing and reflective, and the second sub-assembly S2 is transparent in the visible domain, that is, the layers 112 are transparent to visible light.

In a second non-limiting embodiment, the first sub-assembly S1 is a sub-assembly that is transparent in the visible domain with a light decoupling relief structure 13, that is, said at least one layer 110 is transparent to visible light and comprises a light decoupling relief structure 13, and the second sub-assembly S2 is transparent in the visible domain, that is, the layers 112 are transparent to visible light.

The light decoupling relief structure 13 is configured to decouple the light Lx produced by the light sources 12. The reliefs 130 of the light decoupling relief structure 13 are local modifications of the relief of the surface on which they are located, namely here one of the layers 110 facing the radar sensor 10.

It will be noted if the layer 110 is a diffusing reflective white layer, the light Lx does not propagate in this layer 110, and is sent directly toward the outside of the automotive vehicle 2 due to the light decoupling relief structure 13. Said light decoupling relief structure 13 is arranged so that it sends the light Lx along the vehicle axis Ox of the automotive vehicle 2 and thus makes it possible to perform the luminous function. In non-limiting embodiments, the light decoupling relief structure 13 comprises a plurality of:
mini-disks, also referred to as micro-lenses, obtained by laser impact, and/or
micro-cones, and/or
micro-cone-prisms, and/or
mini-prisms, and/or
embossing.

The reliefs 130 are thus mini-disks and/or micro-cones, and/or micro-cone-prisms and/or mini-prisms and/or embossing. Such a surface is often described as a diffusion surface or micro-lens surface.

The first sub-assembly of layers S1 is configured to send the light Lx produced by the light sources 12 toward the outside of the automotive vehicle 2. Each layer 110 of the first sub-assembly S1 has a primary refractive index n10, also referred to as the refractive index n10, and a primary thickness e10, also referred to as the thickness e10. The first sub-assembly S1 has a total thickness e1 made up of all the thicknesses e10. The layers 110 each have a refractive index n10 very close to the refractive index n10 of another adjacent layer 110, also referred to as contiguous. In one non-limiting embodiment, each layer 110 has a refractive index n10 that differs from the refractive index n10 of an adjacent layer 110 of said first sub-assembly S1 by less than 0.1. This threshold also makes it possible to render the internal reflected waves between the layers 110 of the first sub-assembly S1 negligible. In one non-limiting variant of this non-limiting embodiment, the difference is less than 0.05.

The second sub-assembly of layers S2 is configured to propagate the visible light Lx in the layers 112, which makes it possible to increase the efficiency of the luminous function. Each layer 112 of the second sub-assembly S2 has a secondary refractive index n20, also referred to as the refractive index n20, and a secondary thickness e20, also referred to as the thickness e20. The second sub-assembly S2 has a total thickness e2 made up of all the thicknesses e20. The layers 112 each have a refractive index n20 very close to the refractive index n20 of an adjacent layer 112, also referred to as contiguous. In one non-limiting embodiment, each layer 112 has a refractive index n20 that differs from the refractive index n20 of an adjacent layer 112 of said second sub-assembly S2 by less than 0.1. This threshold also makes it possible to render the internal reflected waves between the layers 112 of the second sub-assembly S2 negligible. In the non-limiting example illustrated, the second sub-assembly S2 comprises two layers 112a and 112b, namely the layer 112a, which acts as a light guide for the light Lx, and the layer 112b, which is a protective layer. The exit layer 112a has a secondary refractive index n20a that differs from the secondary refractive index n20b of the protective layer 112b adjacent to by less than 0.1 in the radar domain. In one non-limiting variant of this non-limiting embodiment, the difference is less than 0.05. In the non-limiting example illustrated, the secondary refractive index n20a is equal to 1.6 and the secondary refractive index n20b is equal to 1.62.

The arrangement of layers 11 thus comprises a total thickness e0=e1+e2 as illustrated in FIG. 5.

The primary refractive index n10 is high with respect to the secondary refractive index n20 in the radar domain. “High” is given to mean that the layers 110 and 112 cannot be considered as equivalent layers. In one non-limiting embodiment, each layer 112 of the second sub-assembly S2 thus has a refractive index n20 that differs from the refractive index n10 of a layer 110 of said first sub-assembly S1 by more than 0.1. There is thus a refractive index difference greater than 0.1 in the radar domain.

In one non-limiting embodiment illustrated in FIG. 5, the first sub-assembly S1 of layers 110 comprises a single layer 110. In one non-limiting embodiment, the layer 110 is a layer of white reflective material. The first sub-assembly S1 of layers 110 is thus a diffusing reflective white layer. This makes it possible to maximize the efficiency of the light sources 12, otherwise half of the visible light Lx would be lost. In one non-limiting variant, the material is made up of particles of titanium TiO2. In one non-limiting example, it is a plastic with a titanium oxide dopant. It will be noted that the greater the titanium oxide doping, the more optically reflective the material, and therefore the higher the refractive index in the radar domain. In one non-limiting embodiment, the doped plastic is PC (polycarbonate). Titanium doping has the advantages of:
using a well-controlled process that makes it possible to obtain uniform distribution on large parts such as a front-end grille, unlike a coat of paint,
and making it possible to vary the reflectivity and thus control the refractive index, unlike a coat of paint. The titanium oxide doped plastic layer 110 contributes to the performance of the luminous function. It will further be noted that the titanium makes it possible to protect the titanium doped plastic. The layer 110 is a layer that is transparent to the radar waves R1, R2 but not to the visible light Lx, that is, it lets through the radar waves R1 but not the visible light Lx, as the latter is largely reflected by the layer 110 (in particular by the interface J12 described hereinafter). In one non-limiting embodiment, its thickness e10 is a few millimeters. In one non-limiting embodiment, the primary refractive index n10 of this layer 110 is equal to 2. It will be noted that the more the concentration of particles of titanium TiO2 is increased, the more reflective the layer 110 and the more its primary refractive index n10 increases. This non-limiting embodiment of a single layer 110 is given as a non-limiting example in the remainder of the description.

In one non-limiting embodiment illustrated in FIG. 5, the second sub-assembly S2 of layers 112 comprises:
an exit layer 112a that forms an exit outer lens of the arrangement of layers 11,
a protective layer 112b that makes it possible to prevent the yellowing of the plastic of the exit outer lens 112a by stopping ultra-violet light.

In one non-limiting embodiment, the protective layer 112b can also be an anti-scratch layer. In one non-limiting embodiment, the exit layer 112a is made from PC. It is a layer that is transparent both to the radar waves R1, R2 and to the visible light Lx. In one non-limiting embodiment, the protective layer 112b has a thickness e20b of substantially 50 micrometers. In one non-limiting embodiment, the protective layer 112b is a deposit of a protective varnish.

As illustrated in FIGS. 3 to 5, when a radar wave R1 is transmitted by the radar sensor 10 it travels to the arrangement of layers 11. The radar wave R1 is reflected by the arrangement of layers 11 and generates four reflected waves R11, R12, R13, R14, namely:
R11, a wave reflected by the outer face S1.1 of the first sub-assembly S1,
R12, a wave reflected inside the arrangement of layers 11 and by the interface J12 between said first sub-assembly S1 and said second sub-assembly S2,
R13 (illustrated in FIG. 5 drawing (a)), a wave reflected inside the arrangement of layers 11 and by the interface J22 between the two layers 112a and 112b of the second sub-assembly,
R14, a wave reflected on the outer face S2.1 of the second sub-assembly S2.

It will be noted that the reflected waves R12, R13 and R14 comprise, before reflection, an incident portion that passes through the layers 110 with respect to R12, 110 and 112a with respect to R13, and 110, 112a and 112b with respect to R14.

In other words, there are waves reflected by each refracting surface defined between two different adjacent layers. The four reflected waves R11 to R14 are reflected waves referred to as first order reflected waves, which return to the radar sensor 10. These are parasitic reflections that disrupt the radar wave R1. The radar wave R1′, which is the radar wave that exits the arrangement of layers 11, will be noted in FIGS. 3 and 4. Due to these parasitic reflections, the radar wave R1 is greatly attenuated relative to the radar wave R1 that enters the arrangement of layers 11. The efficiency of the radar sensor 10 is thus reduced. In order to overcome this problem, as will be seen below, the thicknesses e1 and then e2 are optimized in succession.

The reflection intensity varies from one reflected wave to another. In the non-limiting example illustrated, the reflection intensity of R13 is negligible, as the difference in refractive index between n20a and n20b is extremely small and the Fresnel reflections are therefore negligible. Its reflection intensity is less than 0.5% of the radar wave R1, while the reflection intensity of the reflected waves R11, R12 and R14 varies between 3 and 8% in one non-limiting example. The reflected wave R13 only has very little effect on the transmission of the radar wave R1, while the reflected waves R11, R12 and R14 disrupt the radar wave R1.

If the first sub-assembly of layers 110 comprises a plurality of layers 110, it will be noted that all of the layers 110 of the first sub-assembly S1 can be considered to be equivalent to a single equivalent layer of total thickness e1 with an equivalent refractive index n_{eq1} (illustrated in FIGS. 1, 3 and 4) when the layers 110 each have a refractive index n10 that is very close to the refractive index n10 of another layer 110 that is adjacent, in other words contiguous. It will be remembered that in the non-limiting example given, there is a refractive index difference of less than 0.1.

It will be noted that all of the layers 112 of the second sub-assembly S2 can be considered to be equivalent to a single equivalent layer of total thickness e2 with an equivalent refractive index n_{eq2} (illustrated in FIGS. 1, 3 and 4) when the layers 112 each have a refractive index n20 that is very close to the refractive index n20 of another layer 112 that is adjacent, in other words contiguous. It will be remembered that in the non-limiting example given, there is a refractive index difference of less than 0.1.

It will be remembered that these two secondary refractive indexes n20a and n20b are very far from the primary refractive index n10 in terms of value. There is a big jump in refractive index. There cannot therefore be an equivalent refractive index between the two sub-assemblies S1 and S2 unless the layer(s) 110 has/have a thickness e10 that is significantly smaller the radar wave R1 and negligible compared to the thickness e2 of the layer(s) 112, which is not the case. Significantly smaller is given to mean that e10=λ/10.

In addition, as n10 is significantly greater than n20, there cannot be an equivalent refractive index between the two sub-assemblies S1 and S2.

It will be noted that there could be an equivalent refractive index if n10 was very close or equal to n20, which is also not the case. Due to the large jump in index between n10 and n20, it is not possible for there to be an equivalent refractive index between the first sub-assembly S1 and the second sub-assembly S2 and for the thickness e0 to be optimized.

Conversely, as illustrated in FIGS. 1, 3 and 4, the second sub-assembly S2 has an equivalent refractive index n_{eq2} equal to:

$${n}_{eq} = \frac{{n}_{20 a} {n}_{20 b} ( {e}_{20 a} + {e}_{20 b} )}{{n}_{20 b} {e}_{20 a} + {n}_{20 a} {e}_{20 b}} = \frac{{n}_{20 a} + {n}_{20 b} ( 1 + \frac{{e}_{20}}{{e}_{20}} )}{{n}_{20 b} + {n}_{20 a} ( 1 + \frac{{e}_{20 b}}{{e}_{20 a}} )} \qquad [ Math 1 \}$$

The same principle applies with respect to the first sub-assembly S1 if it comprises a plurality of layers 110 with very close refractive indexes n10. It will have an equivalent index n_{eq1}. It will be noted that a refractive index n can be computed from the permittivity of a layer. Since this computation is known to those skilled in the art, it is not described here.

With the computation of the equivalent index n_{eq2}, the reflected wave R13, which is negligible as it has very low reflection intensity, is no longer taken into account. As illustrated in FIG. 5, drawing (b), the reflected waves R11, R12 and R13 thus continue to hinder the radar sensor 10. The radar wave R1 is thus reflected by the arrangement of layers 11 and generates three reflected waves R11, R12, R13 that have high reflection intensities, that is, a large portion of their energy returns to the radar sensor 10. In this case, there is a reflection intensity value equal to:

$$I ( M ) = R 11 + R 12 + R 14 + 2 \sqrt{R 11 R 12 cos Δφ ( R 11 , R 12 )} + 2 \sqrt{R 11 R 14 cos Δ φ ( R 11 , R 14 )} + 2 \sqrt{R 12 R 14 cos Δ φ ( R 12 , R 14 )} \qquad [ Math 2 ]$$

where:
Δφ(R11, R12) is the phase difference between the reflected waves R11, R12,
Δφ(R11, R14) is the phase difference between the reflected waves R11, R14,
Δφ(R12, R14) is the phase difference between the reflected waves R12, R14.

A minimum reflection intensity value I(M) is obtained when the different layers of the two sub-assemblies S1, S2 are optimized so that they separately cause a phase shift of π modulo 2π so that there is respectively destructive interference between the terms R11 & R14 and R11 & R12. In order to minimize the parasitic waves R11, R12 and R14, R11 and R12 must therefore be in phase opposition to create destructive interference, and R11 and R14 must also be in phase opposition to create destructive interference. The interference phenomena due to the greatest reflections, namely R11, R14, are thus optimized. It will be noted that the term R12&R14 remains in constructive phase, but it has significantly less impact than the sum of the other two terms as the term R12&R14 has lower intensity than the terms R11&R14 and R11&R12.

To this end, in order to reduce the parasitic waves and improve the transmission of the radar waves R1, as the layers 112 of the second sub-assembly S2 can be considered to be an equivalent layer as there is a small refractive index difference between the different layers 112, this equivalent layer is dimensioned so as to have a phase shift of π modulo 2π between R11 and R14. Conversely, if there is a large refraction index difference between two successive layers, they cannot be considered to be an equivalent layer. This is the case for the layer 110 and the equivalent layer formed by the layers 112a and 112b. In this case, each non-equivalent layer must be optimized separately in order to reduce the parasitic waves and improve the transmission of the radar waves R1. In this case, each non-equivalent layer must cause a phase shift of π modulo 2π.

The way in which destructive interference is achieved between R11 and R12 will now be described. As will be seen, to this end, the thickness e1 is optimized.

The total thickness e1 of the first sub-assembly S1 of layers 110 is dimensioned so that there is a phase shift of π modulo 2π between R11 and R12. In other words, the total thickness e1 of the first sub-assembly S1 of layers 110 is dimensioned so that there is a phase shift of π modulo 2π between the waves R11 of the radar waves R1 incident on the outer face S1.1 of the first sub-assembly S1 and the waves R12 reflected by the interface J12 between said first sub-assembly S1 and said second sub-assembly S2 as they exit said first sub-assembly S1.

When the angle of incidence θ differs from 0°, the corresponding refracted angle r also differs from 0°.

The phase difference Δφ, also referred to as the phase shift Δφ, between these two reflected waves R11 and R12 is equal to:

$$Δφ = \frac{{n}_{e q 1} δ}{λ} + π - \frac{2 e 1 t a ( r ) sin ( θ )}{λ} \qquad [ Math 3 ]$$

where:
n_{eq1} is the equivalent refractive index for the first sub-assembly S1, here equal to n10 as there is just one layer 110 in the non-limiting example given,
δ is the path of the reflected wave R12 in the material equal to 2e1/cos(r),
nδ/λ is the phase shift due to the journey through the material,
π is the phase shift due to the internal reflection in the first sub-assembly S1,
((2e1 tan(r)sin(θ))/λ) is the phase shift in air due to the gap between the point of reflection Pt1 of the reflected wave R11 and the point of emergence Pt2 of the reflected wave R12 illustrated in FIG. 3.

As sin(θ)=n_{eq1}×sin(r), the following is obtained:

$$\frac{- 2 e 1 tan ( r ) sin ( θ )}{λ} = \frac{- 2 e 1 {n}_{eq 1} sin {( r )}^{2}}{λ cos ( r )} \qquad [ Math 4 ]$$

$$i . e . :$$

$$Δφ = π + \frac{2 {n}_{e q 1} e 1}{λ cos ( r )} ( 1 - sin {( r )}^{2} ) = π + \frac{2 {n}_{e q} e 1 cos ( r )}{λ} \qquad [ Math 5 ]$$

whatever the value of the refracted angle r.

Given that the reflected waves R11 and R12 return toward the radar sensor 10, they cause disturbances on the radar sensor 10, that is, an attenuation of signal-to-noise ratio. In order to eliminate these disturbances, the total thickness e1 of the first sub-assembly S1 will be defined so that the reflected waves R11 and R12 are in phase opposition, so as to create destructive interference. In order to obtain destructive interference, the phase difference Δφ between the two reflected waves R11 and R12 must be equal to π modulo 2π. Thus, Δφ=(2m+1)*π, where m is a natural integer. The following is therefore obtained:

$$( 2 m + 1 ) π = π + \frac{2 {n}_{e q 1} e 1 cos ( r )}{λ} \qquad [ Math 6 ]$$

$$i . e . :$$

$$i . e . e 1 = m λ / ( 2 {n}_{e q 1} cos ( r ) ) .$$

It will be noted that the equation e1=mλ/(2n_{eq1} cos(r)) is applied whatever the value of the angle r. This total thickness e1 is thus dimensioned so that it is equal to m times a wavelength λ of said range Δ1, the whole being divided by twice an equivalent refractive index n_{eq1} of the first sub-assembly S1 of layers 110, times the cosine of a refracted angle r corresponding to the angle of incidence θ of the radar waves R1, where m is an integer. From the equivalent refractive index n_{eq1} and the wavelength A used in the operating frequency range of the radar sensor 10, the total thickness e1 of the first sub-assembly S1 can thus be determined so that said reflected waves R11 and R12 cancel each other out. In one non-limiting embodiment, the selected wavelength λ is the one located in the middle of said range Δ1.

An ideal total thickness e1 is defined when the angle of incidence is equal to 0; and m is equal to 1. When θ=0, r=0. Consequently, for m=1, the ideal total thickness e1 of the first sub-assembly S1 is therefore e1=λ/(2n_{eq1}), when r=0°, that is cos(r)=1. In other words, here in the non-limiting example of a single layer e1=λ/(2n10).

The total thickness e1 will thus be adapted to obtain the ideal total thickness e1=λ/(2n_{eq1}) when θ=0 or to obtain e1=mλ/(2n_{eq1} cos(r)) when θ≠0.

In one non-limiting embodiment, the first sub-assembly of layers S1 has a total thickness e1 that is between 0.8 and 1.2 times said ideal total thickness e1. This range of values takes into account the possible emission angles of the radar sensor 10. The possible values of the angle of incidence θ are defined in the technical specifications of the radar sensor 10, which means that the possible values of the angle of incidence θ are in the field of view of the radar sensor 10. In one non-limiting example, the angle of incidence θ is between 0° and +/−30°. This range of values from 0.8 to 1.2 allows the manufacturing tolerances of the total thickness e0 to be taken into account. It will be noted that in the non-limiting example given, the thickness e10 of the layer 110 of white reflective material, which is made up of particles of titanium TiO2, is easy to manage with respect to the industrial process involved.

It will be noted that there is a value of the angle of incidence θ for which the reflected radar waves R11 and R12 cause maximum disruption at the receive antennas 101 of the radar sensor 10. This angle of incidence θ is called the critical angle of incidence θ. In one non-limiting embodiment, this value is equal to θ=arctan(d1/(2e4)), where d1 is the distance between the transmit antenna 100 and the receive antennas 101, and e4 is the distance between the radar sensor 10 and the arrangement of layers 11, as illustrated in FIG. 3. In one non-limiting embodiment, the value of the total thickness e1 is thus determined for an angle of incidence θ equal to arctan (d1/(2e4)). It will be noted that, in one non-limiting example, the midpoint of the receive antennas 101 is taken in order to compute d1.

Depending on the value of the total equivalent refractive index neq1 and on the wavelength λ used in the operating frequency range of the radar sensor 10 (between 76 GHz and 81 GHz in the non-limiting example given), it is thus possible determine the value of the total thickness e1 so that the first order reflected waves R11 and R12 cancel each other out. The receive antennas 101 thus experience less noise. A better signal-to-noise ratio is achieved.

Due to the optimization of the thickness e1 and as the layers 110 and 112 are parallel to each other, the path traveled in the thickness e1 between the radar wave R1 and the reflected wave R14 is the same, and the radar wave R1 and the reflected wave R14 therefore strike the interface S1.1 and the interface J1.2 respectively at the same angle of incidence. There is also therefore a phase shift equal to π modulo 2π between the incident portion of the reflected wave R14 that passes through the first sub-assembly S1 on the outward journey (that is, the layer 110) and the portion of the reflected wave R14 that passes through the first sub-assembly on the return journey (that is, the layer 110). These two portions therefore cancel each other out. Thereafter, it is sufficient for there to be destructive interference between the reflected wave R11 and the reflected wave R14 in the second sub-assembly S2. The way in which destructive interference is achieved between R11 and R14 will now be described. As will be seen, to this end, the thickness e2 is optimized (after the thickness e1 has been optimized).

The total thickness e2 of the second sub-assembly S2 of layers 112 is dimensioned so that there is a phase shift of π modulo 2π between R11 and R14. In other words, the total thickness e2 of the second sub-assembly S2 of layers 112 is dimensioned so that there is a phase shift of π modulo 2π between the waves R11 of the radar waves R1 incident on the outer face S1.1 of the first sub-assembly S1 and the waves R14 reflected by the outer face S2.1 of the second sub-assembly S2 as they exit said first sub-assembly S1.

When the angle of incidence θ differs from 0°, the corresponding refracted angle r also differs from 0°.

The phase difference Δφ, also referred to as the phase shift Δφ, between these two reflected waves R11 and R14 is equal to:

$$Δφ = \frac{{n}_{eq 2} δ}{λ} + π - \frac{2 e 2 tan ( r ) sin ( θ )}{λ} \qquad [ Math 7 ]$$

where:
n_{eq2} is the total equivalent refractive index for the second sub-assembly S2,
δ is the path of the reflected wave R14 in the material equal to 2e2/cos(r),
nδ/λ is the phase shift due to the journey through the material,
π is the phase shift due to the internal reflection as the radar wave R1 passes from a low-index medium (air) to a high-index medium (neq1),
((2e2 tan(r)sin(θ))/λ) is the phase shift in air due to the gap between the point of reflection Pt1 of the reflected wave R11 and the point of emergence Pt4 of the reflected wave R14 illustrated in FIG. 4.

As sin(θ)=n_{eq2}×sin(r), the following is obtained:

$$\frac{- 2 e 2 t ( r ) sin ( θ )}{λ} = \frac{- 2 e 2 {n}_{e q 2} sin {( r )}^{2}}{λ cos ( r )} \qquad [ Math 8 ]$$

$$i . e . :$$

$$Δφ = π + \frac{2 {n}_{e q} e 2}{λ cos ( r )} ( 1 - sin {( r )}^{2} ) = π + \frac{2 {n}_{eq 2} e 2 cos ( r )}{λ} \qquad [ Math 9 ]$$

whatever the value of the refracted angle r.

Given that the reflected waves R11 and R14 return toward the radar sensor 10, they cause disturbances on the radar sensor 10, that is, an attenuation of signal-to-noise ratio. In order to eliminate these disturbances, the total thickness e2 of the second sub-assembly S2 will be defined so that the reflected waves R11 and R14 are in phase opposition, so as to create destructive interference. In order to obtain destructive interference, the phase difference Δφ between the two reflected waves R11 and R14 must be equal to π modulo 2π. Thus, Δφ=(2m+1)*π, where m is a natural integer. The following is therefore obtained:

$$( 2 m + 1 ) π = π + \frac{2 {n}_{e q} e 2 cos ( r )}{λ} \qquad [ Math 10 ]$$

$$i . e . :$$

$$i . e . e 2 = m λ / ( 2 {n}_{e q 2} cos ( r ) ) .$$

It will be noted that the equation e2=mλ/(2n_{eq2} cos(r)) is applied whatever the value of the angle r. This total thickness e2 is thus dimensioned so that it is equal to m times a wavelength λ of said range Δ1, the whole being divided by twice an equivalent refractive index n_{eq2} of the second sub-assembly S2 of layers 112, times the cosine of a refracted angle r corresponding to the angle of incidence θ of the radar waves R1, where m is an integer. From the equivalent refractive index n_{eq2} and the wavelength λ used in the operating frequency range of the radar sensor 10, the total thickness e2 of the second sub-assembly S2 can thus be determined so that said reflected waves R11 and R14 cancel each other out. In one non-limiting embodiment, the selected wavelength λ is the one located in the middle of said range Δ1.

An ideal total thickness e2 is defined when the angle of incidence is equal to 0; and m is equal to 1. When θ=0, r=0. Consequently, for m=1, the ideal total thickness e2 of the second sub-assembly S2 is therefore e2=λ/(2n_{eq2}). When r=0°, that is cos(r)=1.

The total thickness e2 will thus be adapted to obtain ideal e2=λ/(2n_{eq2}) when θ=0 or to obtain e2=mλ/(2n_{eq2} cos(r)) when θ≠0. Adjusting the total thickness e2 does not modify the optical performance of the illuminated logo.

The total thickness e2 of the second sub-assembly of layers 112 is thus dimensioned so that the total thickness e2 is equal to said wavelength λ divided by twice the equivalent refractive index n_{eq2} of the second sub-assembly S2 of layers 112, for an angle of incidence θ equal to zero. If the angle of incidence θ differs from zero, e2=mλ/(2n_{eq2} cos(r)) is obtained. This equation is applied whatever the value of the angle of refraction r.

In one non-limiting embodiment, in order to optimize e2, the thickness of just one of the layers 112 of said second sub-assembly S2 is modified. This simplifies the optimization process. In one non-limiting embodiment, the layer into which the light Lx is injected acts as a light guide for said light Lx that will be modified. It will thus be noted that, in practice, the thickness e20a of the exit layer 112a will be adjusted. Since the protective layer 112b is already very thin, its thickness e20b cannot be adjusted. In practice, the thickness e20 of just one layer 112 is thus adjusted, namely the layer that is easiest to inject or the layer made from the least costly material.

In one non-limiting embodiment, the second sub-assembly S2 has a total thickness e2 of between 0.8 and 1.2 times said ideal total thickness e2. This range of values takes into account the possible emission angles of the radar sensor 10. The possible values of the angle of incidence θ are defined in the technical specifications of the radar sensor 10, which means that the possible values of the angle of incidence θ are in the field of view of the radar sensor 10. In one non-limiting example, the angle of incidence θ is between 0° and +/−30°. This range of values from 0.8 to 1.2 allows the manufacturing tolerances of the total thickness e2 to be taken into account.

It will be noted that there is a value of the angle of incidence θ for which the reflected radar waves R11 and R14 cause maximum disruption at the receive antennas 101 of the radar sensor 10. This angle of incidence θ is called the critical angle of incidence θ. In one non-limiting embodiment, this value is equal to 0=arctan (d1/(2e4)), where d1 is the distance between the transmit antenna 100 and the receive antennas 101, and e4 is the distance between the radar sensor 10 and the arrangement of layers 11, as illustrated in FIG. 4. The value of the total thickness e2 is thus determined for an angle of incidence θ equal to arctan (d1/(2e4)). It will be noted that, in one non-limiting example, the midpoint of the receive antennas 101 is taken in order to compute d1.

Depending on the value of the total equivalent refractive index n_{eq2} and on the wavelength λ used in the operating frequency range of the radar sensor 10 (between 76 GHz and 81 GHz in the non-limiting example given), it is thus possible determine the value of the total thickness e2 so that the first order reflected waves R11 and R14 cancel each other out. The receive antennas 101 thus experience less noise. A better signal-to-noise ratio is achieved.

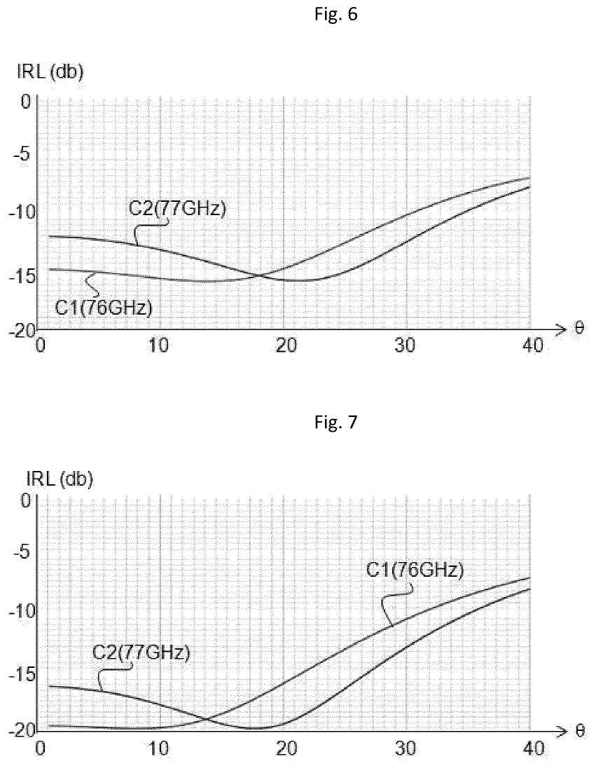

FIG. 6 shows a graph of results following the optimization of the second sub-assembly S2 of the arrangement of layers 11 in order to minimize the effects of the reflected waves R11 and R14 on the radar wave R1, but without optimization of the first sub-assembly S1 of the arrangement of layers 11; the effects of the reflected waves R11 and R12 on the radar wave R1 are still present. R11 and R14 thus produce destructive interference between them, while R11 and R12 produce constructive interference between them. The angle of incidence θ is shown on the x-axis and the intensity of reflection IRL in decibels (dB) is shown on the y-axis. There are two curves C1, C2 for two angles of incidence θ of 76 GHz and 77 GHz respectively.

FIG. 7 shows a graph of results following the optimization of the second sub-assembly S2 of the arrangement of layers 11 in order to minimize the effects of the reflected waves R11 and R14 on the radar wave R1 and the optimization of the first sub-assembly S1 of the arrangement of layers 11 in order to minimize the effects of the reflected waves R11 and R12 on the radar wave R1. R11 and R14 thus produce destructive interference between them, and R11 and R12 also produce destructive interference between them. The angle of incidence θ is shown on the x-axis and the intensity of reflection IRL in decibels (dB) is shown on the y-axis. There are two curves C1, C2 for two angles of incidence θ of 76 GHz and 77 GHz respectively.

In the graph in FIG. 6, there is a mean intensity of reflection IRL of −10 dB when only the disturbances due to the reflected waves R11 and R14 are processed, while in the graph in FIG. 7, there is a mean intensity of reflection of −16 dB when the disturbances due to the reflected waves R11 and R12 are processed in addition to the disturbances due to the reflected waves R11 and R14. There is thus a gain of 6 dB when the disturbances due to the reflected waves R11 and R12 and those due to the reflected waves R11 and R14 are processed.

Of course, the description of the invention is not limited to the embodiments described above and to the field described above. In another non-limiting embodiment, the radar sensor 10 thus comprises more than one transmit antenna 100 and more than two receive antennas 101. In one non-limiting embodiment, the thickness e2 can thus be dimensioned before the thickness e1, or in parallel.

The described invention thus has the following advantages in particular:
it makes it possible to minimize the first order reflected waves R11, R12 and R14 that are reflected toward the radar sensor 10. The signal-to-noise ratio of said radar sensor 10 is thus no longer low. The transmission of the radar waves R1 is improved,
it makes it possible to minimize the reflected waves R11, R12 and R14 by modifying the total thickness e1 and the total thickness e2, therefore by modifying the diffusing reflective white layer 110 and modifying the transparent layers 112,
it makes it possible to minimize the waves R11 and R12 reflected between two non-equivalent layers having significantly different refractive indexes.

What is claimed is:

1. A vehicle assembly for a vehicle, the vehicle assembly comprising:
a radar configured to transmit radar waves in a range of wavelengths; and
an arrangement of layers placed facing the radar sensor and configured to perform a luminous function, the arrangement of layers including a first sub-assembly of at least one layer that is reflective in the visible domain, each layer having a primary refractive index and a primary thickness, and a second sub-assembly of at least one layer that is transparent in the visible domain, each layer having a secondary refractive index, with the primary refractive index being high with respect to the secondary refractive index in the radar domain,
and the total thickness of the first sub-assembly of layers is dimensioned so that there is a phase shift of π modulo 2π between the waves of the radar waves incident on the outer face of the first sub-assembly and the waves reflected by the interface between the first sub-assembly and the second sub-assembly as they exit the first sub-assembly.

2. The vehicle assembly as claimed in claim 1, wherein the total thickness of the second sub-assembly of layers is dimensioned so that there is a phase shift of π modulo 2π between the waves of the radar waves incident on the outer face of the first sub-assembly and the waves reflected by the outer face of the second sub-assembly as they exit the first sub-assembly.

3. The vehicle assembly as claimed in claim 1, wherein the total thickness of the second sub-assembly of layers is dimensioned by modifying the thickness of just one of the layers of the second sub-assembly.

4. The vehicle assembly as claimed in claim 1, wherein each layer of the first sub-assembly has a refractive index that differs from the refractive index of another adjacent layer of the first sub-assembly by less than 0.1 in the radar domain.

5. The vehicle assembly as claimed in claim 1, wherein each layer of the second sub-assembly has a refractive index that differs from the refractive index of another adjacent layer of the second sub-assembly by less than 0.1 in the radar domain.

6. The vehicle assembly as claimed in claim 1, wherein each layer of the second sub-assembly has a refractive index that differs from the refractive index of a layer of the first sub-assembly by more than 0.1 in the radar domain.

7. The vehicle assembly as claimed in claim 1, further comprising at least one light source configured to emit visible light that enters the arrangement of layers through an edge of one of the layers of the second sub-assembly of the arrangement of layers.

8. The vehicle assembly as claimed in claim 1, wherein the at least one layer that is reflective in the visible domain is made up of particles of titanium (TiO2).

9. The vehicle assembly as claimed in claim 1, wherein the arrangement of layers forms an illuminated logo or an illuminated front-end grille or forms part of a headlamp.

10. An arrangement of layers placed facing a radar sensor, the radar sensor being configured to transmit radar waves in a range of wavelengths, the arrangement of layers being configured to perform a luminous function and includes a first sub-assembly of at least one layer that is reflective in the visible domain, each layer having a primary refractive index and a primary thickness, and a second sub-assembly of at least one layer that is transparent in the visible domain, each layer having a secondary refractive index, the primary refractive index being high with respect to the secondary refractive index,
and the total thickness of the first sub-assembly of layers is dimensioned so that there is a phase shift of π modulo 2π between the waves of the radar waves incident on the outer face of the first sub-assembly and the waves reflected by the interface between the first sub-assembly and the second sub-assembly as they exit the first sub-assembly.
